(19) United States
(12) Patent Application Publication
(10) Pub. No.: US 2009/0178015 A1
(43) Pub. Date: Jul. 9, 2009

(54) METHOD AND SYSTEM FOR REDUCING TURN AROUND TIME OF COMPLICATED ENGINEERING CHANGE ORDERS AND ASIC DESIGN REUTILIZATION

(75) Inventors: Dov Federovsky, Kiryat Bialik (IL); Dmitry Kamshitsky, Petach Tiqva (IL); Inna Vaisband, Tel Aviv (IL); Boaz Yeger, Zichron Ya'akov (IL)

Correspondence Address: Cantor Colburn LLP-IBM Europe, 20 Church Street, 22nd Floor, Hartford, CT, 06103, US

(73) Assignee: International Business Machines Corporation, Armonk, NY (US)

(21) Appl. No.: 11/969,551

(22) Filed: Jan. 4, 2008

(51) Int. Cl. G06F 17/50

(52) U.S. Cl. 716/3

(57) ABSTRACT

Reducing turn around time of engineering change orders in ASIC re-spin design includes finding, on the fly, all corresponding boundary points of storage gate elements indicated by engineering change orders to be either added, deleted or renamed. Boolean equivalence tools are used between an old spin ASIC design and a new ASIC design netlist, as well as between the new ASIC design netlist and a new re-spin ASIC design to obtain failing boundary storage gate elements and perform one or more of adding, deleting or modifying or renaming all failing boundary storage gate elements, so they pass correspondence tests. Engineering change order scripts are automatically generated to indicate which storage logic gate elements are to be added, deleted or modified and the scripts are applied to the old ASIC design to obtain the new re-spin ASIC design, after which ASIC flow gate level fixes are applied to synthesized storage gate elements.

### TECHNICAL FIELD

The present invention relates generally to design, development and manufacturing of integrated circuits (ICs) on semiconductor chips, for use in automated computing systems. More particularly, the present invention relates to reducing the complexity of design and verification tasks in the physical design of new versions of application specific integrated circuit (ASIC) design.

### BACKGROUND

Known methods and systems for the production of ASIC re-spin in non-hierarchical design is based on several releases, where the first version is designed with limited availability editions (e.g. for production modeling, board testing and debugging purposes) and the successor editions are released based on the gathered feedback from the preliminary production models. It is common to re-design these preliminary productions models from scratch, in terms of time and risk critical, physical design (PD) parameters and re-verify the models from the very beginning. It is desirable to preserve some portions of the chip which are timing/PD critical and it is difficult to solve critical timing/PD parameters from the previous spin in terms of time, production yield (PY) and expertise needed; this results in high risks, in regard to meeting schedules, because of the need to spend time in duplicating efforts of solving those critical portions from the previous spin, where additional PY and expertise are needed from the previous spin. Another aspect is the implementation of complex design changes in the PD netlist after a design freeze. An engineering change order (ECO) is needed to update any design freeze, so as to match re-synthesized code, because generating a new netlist for PD after a design freeze is inefficient, because of the loss of PD work. As device geometries shrink and designs are required to support high-performance and low-power levels, avoiding signal routing congestion, solving signal integrity issues, solving noise issues and achieving specified timing results, become more important in the design of reuse application specific integrated circuits (ASICs). Thus, incorporating a complex logic change requires numerous iterations until a Boolean equivalence criterion is achieved. Furthermore, manually describing the necessary changes at the gate level is a time-consuming, error prone, iterative task; and there is no known way of automatically identifying and listing all of the desired boundary logic points that are needed to be implemented in an engineering change order for all design changes in a re-spin of an ASIC design. Consequently, changes will sometimes be deferred until a follow up chip is approved and budgeted for. Therefore, an efficient method of ASIC full-custom flow that achieves reduced time-to-market and lowered workload and increases confidence in the delivered design is also important in the design of reuse ASICs.

### SUMMARY OF THE INVENTION

A method, and system are disclosed herein for reducing turn around time of engineering change orders when performing ASIC re-spin designs. Computer executable program code in a local computer which is part of a computer system, causes the local computer to find, contemporaneously, all corresponding boundary points of storage gate elements indicted by engineering change orders to be either added, deleted, or modified. The group of engineering change orders includes a group of scripts that are applied to a reliability test chip (RTC) starting point design and a new post front end processing design, and wherein the finding operation performs the sub operations of running a first Boolean equivalence tool between an old spin ASIC design and a new ASIC design netlist. A first generating sub operation, automatically generates a first script from the group of scripts including a first group of storage gate elements that were either added, deleted, or modified or renamed on an old ASIC spin design and saves the new netlist as the new re-spin ASIC design. The first group of storage gate elements includes one or more of FLOPs, arrays and built-in-self-test gates. The first script includes the first group of gate elements added, deleted and/or modified that caused a failing model correspondence because of uncorrespondence between the old spin ASIC design and the new re-spin ASIC design. A second script is applied to the old spin ASIC design to obtain a new design netlist and the new design netlist ASIC design is saved as a new re-spin ASIC design. A second Boolean equivalence tool is run between the new design netlist and the new re-spin ASIC design to obtain all falling boundary storage gate elements and to perform cutting, pasting deleting, modifying and/or renaming all failing boundary storage gate elements to pass correspondence tests. And, after running a cleanup operation, an applying operation, applies ASIC flow gate level fixes to cloned synthesized storage gate elements.

The above-described and other features will be appreciated and understood by those skilled in the art from the following detailed description, drawings, and appended claims.

### DETAILED DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings, which are meant to be exemplary, and not limiting, wherein:

FIG. 1 illustrates a method of carrying out an exemplary embodiment of efficient ASIC re-spin design.

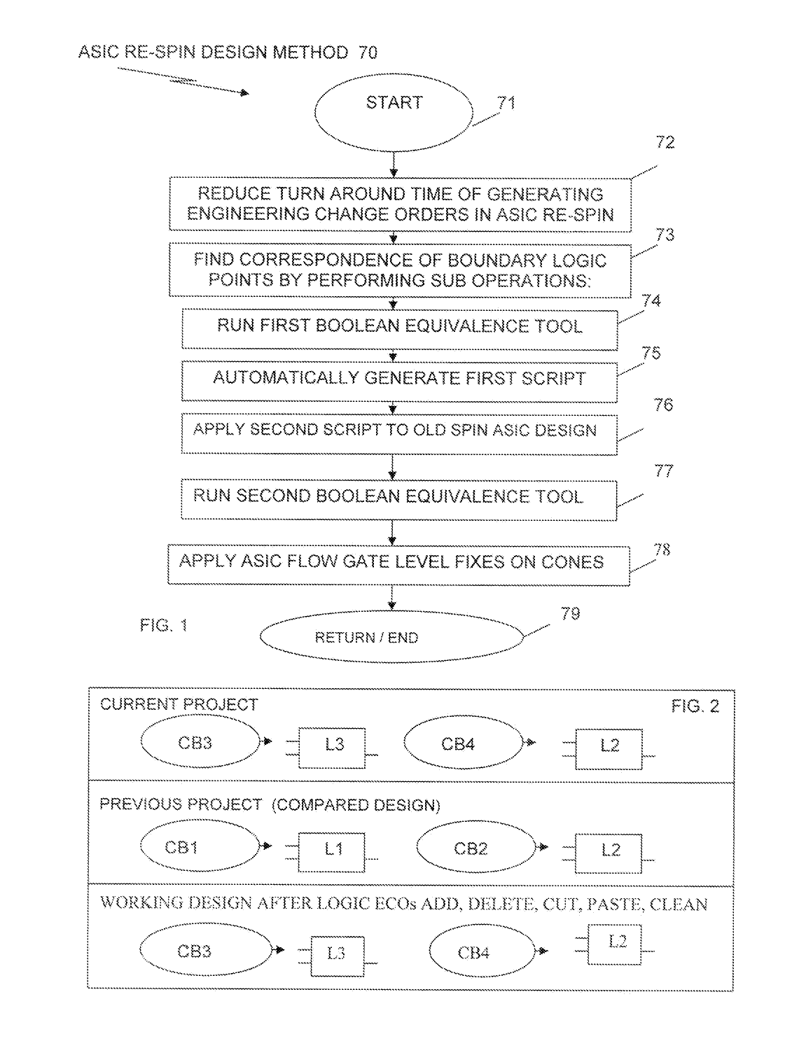

FIG. 2 illustrates a plurality of correspondence boundary clouds and a plurality of associated logic gates in a current project, previous project, and working design alter logic engineering change order scenarios.

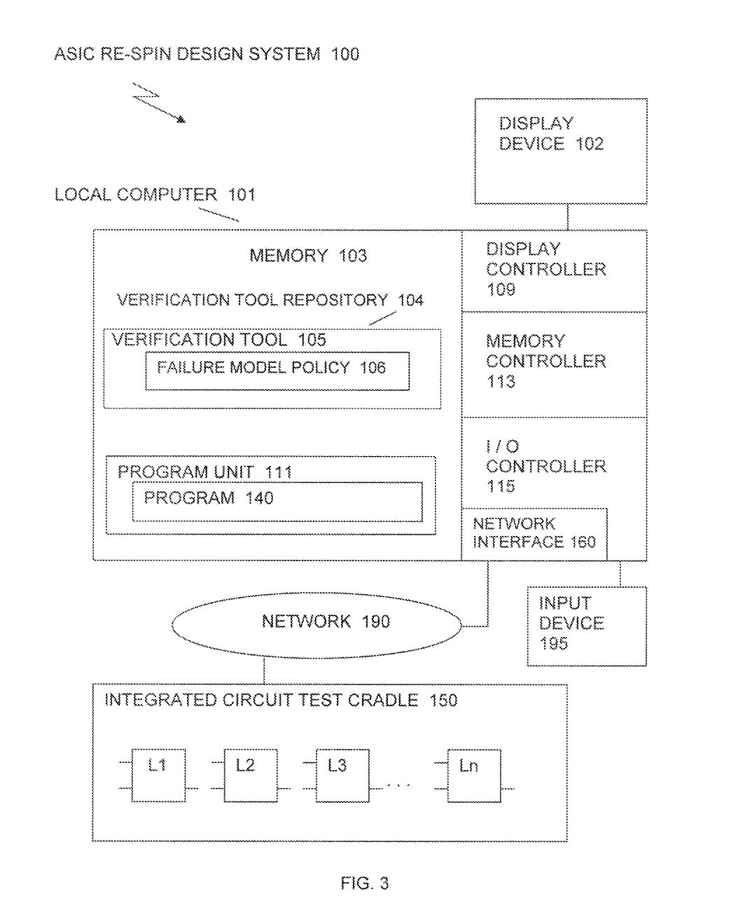

FIG. 3 illustrates the system implementation of the exemplary embodiment of efficient ASIC re-spin design.

### DETAILED DESCRIPTION

The exemplary embodiment of the invention is described below in detail. The disclosed exemplary embodiment is intended to be illustrative only, since numerous modifications and variations therein will be apparent to those of ordinary skill in the art. In reference to the drawings, like numbers will indicate like parts continuously throughout the view. Further, the terms “a”, “an”, “first”, “second” and “third” herein do not denote a limitation of quantity, but rather denote the presence of one or more of the referenced item.

The exemplary embodiments will be understood by referring to FIGS. 1, 2 and 3. An ASIC re-spin design method 70 is illustrated in FIG. 1. Current project, previous project and working design after logic engineering change order scenarios are illustrated in FIG. 2. Further, the ASIC re-spin design method 70 is implemented in the ASIC re-spin design system 100, illustrated in FIG. 3.

Referring to FIG. 3, the ASIC re-spin design system 100 (hereafter system 100) includes local computer 101 connected over network 190 to integrated circuit test cradle 150, which contains a plurality of ASICs each having a plurality of logic gates L1, L2, L3 up to Ln. Network 190 can be a wired and/or a wireless local area network or a wide area network, including an extranet or the Internet. Local computer 101 includes at least an input device 195 a display device 102, a network interface 160 and an assortment of internal and external controllers and/or peripheral devices including display controller 109, memory controller 113 and input/output (I/O) controller 115. The network interface 160 can be, for example but not limited to, one or more buses or other wired or wireless connections, as known in the art. The network interface 160 may have additional elements, which are omitted for simplicity, such as controllers, buffers (caches), drivers, repeaters, and receivers, to enable communications. Further, the network interface 160 may include address, control, and/or data connections to enable appropriate communications among the aforementioned components.

Referring to FIG. 3, input device 195 can include a mouse, a keyboard, a touch screen, a light pen. Local computer 101 also includes memory 103. Residing in memory 103 is program unit 111, which contains program 140. Also, residing in memory is verification tool repository 104, which includes one or more verifications tools. In the exemplary embodiment, verification tool 105 is illustrated. Verification tool 105 can contain a plurality of policies as represented by failure model policy 106, also illustrated in FIG. 3. Program 140, verification tool 105 and failure model policy 106 can include any computer executable program code or algorithm or application software or hardware description language (HDL) that can be stored on a computer executable medium, including memory 103 and can be compiled, called and run on a general purpose computer processor, or stand alone computing system such as local computer 101, so as to cause local computer 101 to perform certain operations and sub operations.

The memory 103 can include any one or combinations of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge or cassette). Moreover, the memory 103 may incorporate electronic, magnetic, optical, and/or other types of storage media. Note that the memory 103 can have a distributed, architecture, where various components are situated remotely from one another, but can be accessed by the local computer 101.

Referring to FIGS. 1 and 3, the exemplary embodiment of the ASIC re-spin design method 70, illustrated in FIG. 1 will be described as implemented in system 100, which is illustrated in FIG. 3. Computer executable code in program 140 when executed by local computer 101, causes local computer 101 to perform the operation start 71, to initiate the local computer 101 to perform the operations of ASIC re-spin design method 70.

At operation 72, program 140, when executed by local computer 101, causes local computer 101 to reduce turn around time associated with generating a group of complicated, engineering change orders when performing the operations and associated sub operations of ASIC re-spin design. During these operations and sub operations, method 70 automatically identifies and lists all of the desired boundary logic points that are needed to be implemented in engineering change orders (ECOs); thus, providing a simple automated way of finding logic points in a mainly flat netlist, because any given netlist in a complicated ASIC re-spin design operation mainly a flat netlist is not 100 percent correlated to any given original hardware description language.

At operation 73, program 140, when executed by local computer 101, causes local computer 101 to find contemporaneously (on the fly), all corresponding boundary points of storage gate elements indicated by engineering change orders needing to be one or more of added, deleted and/or modified, in order to meet the correspondence tests. In the exemplary embodiment, the group of engineering change orders includes a group of scripts that apply to a reliability test chip starting point design and a new post front end processor design. From these starting points, Boolean, equivalence tools and automated scripts are used to identify previous ASIC spins that need to be reconfigured and/or reprogrammed into a new re-spin ASIC design, while preserving some portions of the gate configurations on the old ASIC chip which are timing/physical design (timing/PD) critical. Therefore, major, fine-tuned reconfigured portions of an existing ASIC after PD design can be reused and integrated with additional logic needed for the new version of the reused ASIC design. Thus, using this approach preserves the design of critical blocks of standard, and high frequency double data rate synchronous dynamic RAM (DDR), peripheral component interconnect extensions (PCIX) and lowers the PD risk factor and the complexity of gate-level ECOs. This automated ASIC re-spin design method 70 will reduce the need for experts to reconfigure the logic gates and this automated method will save money and time attributed to manual reconfiguration of ASIC logic gates for reuse, as well as increase production yield (PY) over manual ASIC re-spins. Logic ECOs are sets/groups of scripts that can be applied to both the reliability test chip start point of the compared previous project and the new post front end processor (postFEP) golden/current project designs for the purpose of changing the compared previous design, so it will be functionally identical to the golden/current project design. Scripts applied to the current project gather information about the vim, but never change it. Scripts applied to the compared design modify the data paths of the compared design, according to the gathered information. Logic ECO scripts consist of two main groups. The first group is the add and delete group which, solves uncorrespondence problems, by adding and/or deleting latches, PIOs and Black Boxes from previous designs. In addition, lists of logic gates that must be added and/or removed are determined based on an output of model correspondence, i.e., whether the correspondence is clean or if it is a failed correspondence. The second group is the cut and paste group which is executed after successful completion of correspondence stage operation and resolution of Boolean equivalence failures, by disconnecting storage gate elements in the compared list of gates that cause failing storage gate elements based on VERITY verification testing. The operations of these two logic ECO scripts are followed by a clean up process. Based on the descriptions of these logic ECO scripts, the finding operation, i.e., operation 73 is further understood by the descriptions of the following sub operations.

Referring to FIGS. 1, 2 and 3, at sub operation 74 illustrated in FIG. 1, program 140, causes local computer 101 (illustrated in FIG. 3) to run a first Boolean equivalence tool between a previous project, such as an old ASIC spin design and a new ASIC design netlist for a current project, where the previous and current projects are illustrated in FIG. 2. In this sub operation, all of the added, removed, modified and/or renamed storage gate elements, such as FLOPS, arrays, and built-in self-test gates are collected. All of these added, removed, modified and/or renamed storage gate elements caused uncorrespondence failures between the current and previous design projects.

At sub operation 75, program 140, causes local computer 101 to automatically generate a first script from the group of scripts including a first group of storage gate elements that were either added, deleted, modified and/or renamed on the old spin, i.e., previous project arid automatically save the new netlist as the new re-spin for the current project. The first group of storage gate elements includes one or more of the FLOPs, arrays and built-in-self-test gates. The first script includes the first group of gate elements added, deleted and modified that caused the failing model correspondence because of uncorrespondence between the old spin ASIC design previous project and the new re-spin ASIC design current project.

At sub operation 76, program 140, causes local computer 101 to apply a second ECO script to the old spin ASIC design to obtain a new design netlist and save the new design netlist ASIC design as a new re-spin ASIC design.

At sub operation 77, program 140, causes local computer 101 to run a second Boolean equivalence tool between the new design netlist and the new re-spin ASIC design to obtain all failing boundary storage gate elements and perform one or more of cutting, pasting, deleting, adding and/or renaming all failing boundary storage gate elements in order to pass correspondence tests, followed by a cleanup operation.

At operation 78, program 140, causes local computer 101 to apply ASIC flow gate level fixes with cloned synthesized storage gate elements, which will automatically generate a set of scripts that when applied on the re-spin netlist will provide Boolean equivalence to the new current project netlist.

Referring to FIGS. 1, 2 and 3, in the exemplary embodiment, the automatic generation of the first scripts in sub operation 75, of method 70 uses a cut and paste technique of copying netlist fragments from a golden, i.e., newly synthesized, current project netlist to a PD netlist. This concept is based on identifying storage gate elements in both netlists using formal verification tools, such as, but not limited to VERITY, VERPLEX AND FORMALITY. Thus, verification tool 105 can be any one or more of the verification tools including, but not limited to VERITY, VERPLEX AND FORMALITY. Therefore, verification tool 105 verifies the logic in the golden, newly synthesized, current project netlist that needs to be modified in the problem determination netlist. Therefore, as described above in the finding correspondence operation, i.e., in operation 73, the logic in the current project netlist (as illustrated in FIG. 2) is traced/identified and based on this finding of the logic, then generates on the fly engineering change orders to build the storage gate element, as described in sub operation 75. Referring to scenarios illustrated in FIG. 2, next, the previous project is compared to the current project and the storage gate element's logic is deleted from the PD netlist; further, the previous project is compared to the current project after cutting and pasting, as well as adding and deleting and the engineering change orders that were generated on the PD netlist are applied to the new ASIC re-spin to obtain a new design netlist and saving the new design netlist ASIC design as a new re-spin ASIC design, after cleaning up any floating nets and objects and correspondence boundaries floating from the compared design after adding deleting and cutting and pasting; thereby forming the working design after the logic ECOs scenario, illustrated in FIG. 2.

Referring to FIG. 2, a given reliability test chip design from a pervious project, which is labeled the previous project (compared design), as illustrated in FIG. 2, is modified so it will be functionally identical to the register transfer level (RTL) design of the current project, also illustrated in FIG. 2. Thus in step one, all sequential logic, such as PIOs and Black Boxes are removed and/or added to make the logic correspondence, resulting in L1 being removed and adding L3, while L2 remains connected to correspondence boundary (CB) 2, and CB1 is floating. In step two, Boolean equivalency is passed, combinatorial logic is disconnected in failed storage gate elements and the storage gate elements are rebuilt backwards as they appear in the current project This results with CB1 still floating and CB2 is disconnected and becomes floating. CB2 is determined to be equivalent to CB4. Then CB3 and CB4 are added and connected to L3 and L2 respectively and a cleanup operation removes the floating nets and gates, resulting in CB1 and CB2 being removed and the configuration in the working design, after logic ECOs add, delete, cut, paste is functionally identical to the current project, as illustrated in FIG. 2.

Thus, this process provides a modified netlist for the back-end which contains all of the functionality of the new register transfer level design and provides maximized preservation of the reliability test chip start point design properties and qualities, which were derived from the modified netlist based on the editing of the current compared design using the add, delete and cut and paste ECO scripts. This process also provides a new reliability test chip design for synthesis into the front end processor of the golden netlist, i.e., the current project design. Thus, providing the useful, concrete, and tangible result of automatically reconfiguring and reusing portions of ASIC logic blocks while preserving the design of critical logic blocks, by automatically finding netlists that do not correlate to an original hardware description language. Thereby further providing manpower savings, dollar savings along with reducing PD risk factors and reducing the complexity of gate-level engineering change orders.

At any stage of the ASIC re-spin design method 70, the method can be directed to operation return/stop 79 by program 140, where the status of failure model policy 106 can be updated or the verification tool 105 can be updated or additional iterations of Boolean equivalences can be run and/or additional ECO scripts can be generated, indicating additional corresponding boundary points by return operation or the method can he directed to stop.

The disclosure has been described with reference to the exemplary embodiment, where for example, the RTC design from a previous project is rendered functionally identical to the RTL design of the current project.

The capabilities of the present invention can be implemented in software, firmware, hardware or some combination thereof.

The local computer 101 is a hardware device for executing software, particularly that is stored in memory 103. The local computer 101 can contain any custom made or commercially available processor, a central processing unit (CPU), an auxiliary processor among several processors associated with the local computer 101, a semi conductor based microprocessor (in the form of a microchip or chip set), a macroprocessor, or generally any device for executing software instructions,

The program 140 in memory 103 may include one or more separate programs, algorithms, or routines each, of which comprises an ordered listing of executable instructions for implementing logical functions. In the example of FIG. 3, the program 140 in the memory 103 includes the method 70 in accordance with the present invention and a suitable operating system (O/S), including Windows based operating systems.

Additionally, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present Invention can be provided.

In the context of this document, a “computer-executable and/or readable medium” can be any medium that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium, upon which the program is printed, as the program can be electronically captured, via for instance optical scanning of paper or other media, then compiled, interpreted or otherwise processed in a suitable manner if necessary, and then stored in a computer memory.

The flow diagrams depicted herein are just examples. There may be many variations to these diagrams or the steps (or operations and/or sub operations) described therein without departing from the spirit of the invention. In the exemplary embodiment, the operations may be performed in a differing order, or operations may be added, deleted or modified. All of these variations are considered a part of the claimed invention.

In addition, many modifications may be made to adapt a particular situation or material to the teachings of the disclosure without departing from the essential scope thereof. For example, the method of determining active and expired status can be carried out by at least polling and/or interrupt operations. It will be understood by those skilled in the art that various changes may be made and equivalents may be substituted for elements thereof without departing from the scope of the disclosure. Therefore, it is intended that the disclosure not be limited to any one particular embodiment disclosed as the best mode contemplated for carrying out this disclosure, but that the disclosure will include all embodiments falling within the scope of the appended claims.

While the preferred embodiment to the invention has been, described, it will be understood that those skilled in the art, both now and in the future, may make various improvements and enhancements which fall within the scope of the claims which follow. These claims should be construed to maintain the proper protection for the invention first described.

In addition, many modifications may be made to adapt a particular situation or material to the teachings of the disclosure without departing from the essential scope thereof. It will be understood by those skilled in the art that various equivalents may be substituted for elements thereof without departing from the scope of the disclosure. Therefore, it is intended that the disclosure not be limited to any one particular embodiment disclosed as the best mode contemplated for carrying out this disclosure, but that the disclosure will include all embodiments failing within the scope of the appended claims.

What is claimed is:

1. A method, implemented in a computer system, of reducing turn around time of a group of engineering change orders when performing ASIC re-spin designs, by automatically identifying and listing all the desired boundary logic points that are needed to be implemented in the group of engineering change orders, wherein the computer system contains a local computer including a computer readable storage medium containing a computer executable program that when executed by the local computer causes the local computer to perform the method comprising;
in a finding operation, finding contemporaneously by the local computer, all corresponding boundary points of storage gate elements indicted by engineering change orders to be one of added, deleted, and modified, wherein the group of engineering change orders includes a group of scripts that apply to a reliability test chip starting point design and a new post front end processor design, and wherein the finding operation performs:
running a first Boolean equivalence tool between an old spin ASIC design and a now ASIC design netlist, wherein the netlist is not correlated to an original hardware description language, and wherein all added, removed, modified and renamed storage element storage gate elements are collected;
automatically generating a first script from the group of scripts including a first group of storage gate elements that are one or more of added, deleted, and modified on an old spin and saving the new netlist as the new re-spin, wherein modified includes renamed, wherein the first group of storage gate elements includes one or more of FLOPs, arrays and built-in-self-lest gates, wherein the first script including the first group of storage gate elements added, deleted and modified caused a failing model correspondence because of uncorrespondence between, the old spin ASIC design and the new re-spin ASIC design;
running a second Boolean equivalence tool between the new design netlist and the new re-spin ASIC design to obtain all failing boundary storage gate elements and performing one or more of cutting, pasting deleting and renaming all failing boundary logic storage gate elements to pass correspondence; and
in an applying operation, applying ASIC flow gate level fixes with cloned synthesized storage gate elements, wherein a useful, concrete, and tangible result of automatically reconfiguring portions of ASIC logic blocks while preserving designs of critical logic blocks, for reuse by automatically finding netlists that do not correlate to an original hardware description language.

2. The method of claim 1, wherein the group of scripts from the group of engineering change orders includes an add and delete group that solves uncorespondence problems by adding and deleting latches, primary input/output elements and black boxes from a previous design and includes a cut and paste group executed alter successful completion of correspondence tests and includes a cleanup process.
